(19) United States
(12) Patent Application Publication
(10) Pub. No.: US 2007/0168572 A1
(43) Pub. Date: Jul. 19, 2007

(54) COMMUNICATION SYSTEM, PERIPHERAL DEVICE, AND COMPUTER USABLE MEDIUM THEREFOR

(75) Inventor: Masafumi Miyazawa, Nagoya, Aichi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya (JP)

(21) Appl. No.: 11/611,375

(22) Filed: Dec. 15, 2006

(30) Foreign Application Priority Data
Dec. 16, 2005 (JP) 2005-363255

(51) Int. Cl. G06F 3/00

(52) U.S. Cl. 710/8

(57) ABSTRACT

A communication system, comprising at least one peripheral device having a plurality of interfaces and a host computer which is capable of communicating with the at least one peripheral device through any one of the plurality of the interfaces is provided. The at least one peripheral device comprises a storing system and a configuration information transmission system. The host computer comprises a configuration information reception system and a setting screen display system. The communication system further comprises a screen display controlling system.

### CROSS REFERENCE TO RELATED APPLICATION

This application claims priority from Japanese Patent Application No. 2005-363255, filed on Dec. 16, 2005, the entire subject matter of which is incorporated herein by reference.

### BACKGROUND

1. Technical Field

Aspects of the present invention relate to a peripheral device incorporating a plurality of interfaces, a communication system having such a peripheral device and a host computer, and a program for the peripheral device.

2. Related Art

Conventionally, a printing apparatus connected with a host computer through a interface such as a LAN interface and a USB interface is known. Also, the printing apparatus having a plurality of interfaces for communicating with a host computer is known, and an example of such a printing apparatus is disclosed in Japanese Patent Provisional Publication No. HE18-314651. Further, mobile computers have become widespread in recent years, and in keeping with this trend, various communication systems mixed with a wired LAN and a wireless LAN have been increasingly built in many offices and companies.

### SUMMARY

Aspects of the present invention are advantageous in that a communication system having a peripheral device being equipped with a plurality of interfaces and a host computer, wherein operability in configuring and configuration checking operation of each of the interface is improved, is provided.

### BRIEF DESCRIPTION OF THE ACCOMPANYING DRAWINGS

FIG. 1 is a schematic diagram showing a configuration of a communication system according to a first embodiment of the present invention.

FIG. 2 is an illustrative diagram showing a configuration of communication management data stored in an EEPROM according to the first embodiment of the present invention.

FIG. 3 is a flowchart showing a request acceptance process to be executed repeatedly by a CPU of a printing apparatus according to the first embodiment of the present invention.

FIG. 4 is an illustrative diagram showing a storing manner of connection interface numbers in management PCs according to the first embodiment of the present invention.

FIG. 5 is a flowchart showing a communication configuration process to be executed by CPUs of the management PCs according to the first embodiment of the present invention.

FIGS. 6A, 6B are illustrative diagrams showing a communication configuration window according to the first embodiment of the present invention.

FIG. 7 is a flowchart showing a request acceptance process to be executed repeatedly by a CPU of a printing apparatus according to a second embodiment of the present invention.

FIG. 8 is a flowchart showing a communication configuration process to be executed by a CPU of a management PC according to the second embodiment of the present invention.

FIG. 9 is a flowchart showing a web server process to be executed repeatedly by a CPU of a printing apparatus according to a third embodiment of the present invention.

FIG. 10 is a flowchart showing a setting screen creation transmission process to be executed by the CPU of the printing apparatus according to the third embodiment of the present embodiment.

FIG. 11 is an illustrative diagram showing a configuration of a web page to be transmitted in the web server process according to the third embodiment of the present invention.

### DETAILED DESCRIPTION

General Overview

The following describes general aspects of the invention that may or may not be included in various examples and modifications. It should be noted that various connections are set forth between elements in the following description. It should be noted that these connections in general and, unless specified otherwise, may be direct or indirect and that this specification is not intended to be limiting in this respect.

According to some aspects of the invention, there is provided a communication system, comprising at least one peripheral device having a plurality of interfaces and a host computer which is capable of communicating with the at least one peripheral device through any one of the plurality of the interfaces. The at least one peripheral device comprises a storing system to store configuration information which determines an operation of each of the interfaces and a configuration information transmission system to transmit the configuration information of each of the interfaces stored in the storing system to the host computer through any one of the plurality of the interfaces which are capable of communicating with the host computer. The host computer comprises a configuration information reception system to receive the configuration information of each of the interfaces transmitted by an operation from the configuration information transmission system from the at least one of the peripheral device and a setting screen display system to display a setting screen with the configuration information in the storing system being indicated therein on an interface basis according to the configuration information received by the configuration information reception system.

Optionally, a screen display controlling system to display the setting screen of one of the interfaces that relays communication between the host computer and the at least one of the peripheral device preferentially among the plurality of interfaces provided to the at least one of the peripheral device on the setting screen display system may be included in the communication system.

With the above configuration, the setting screen which relates to communication between the host computer as operation object and the peripheral device may be considered the most essential screen for a user operating on the host computer. Therefore, by displaying the setting screen of the interface which relays communication between the host computer and the peripheral device preferentially may reduce operational load, which may be required for checking operation of configuration information through the setting screen, on the host computer. Thus, in the communication system configured as above, operability on configuration check operation is improved, and the user can perform an operation such as configuration check operation without being involved in complicated operations.

Meanwhile, the screen display controlling system may be provided in either the peripheral device or the host computer. When the screen display controlling system is provided in peripheral device, identification of the interface which relays communication between the host computer and the peripheral device can be performed more easily than when the screen display controlling system is provided in other than the peripheral device.

Further, the setting screen display system may be configured to display a window corresponding to each interface on the display unit and display the setting screen of the corresponding interface in each window, and display the page arranged scrollably with the setting screen corresponding to each interface in the window. In the first case, by setting the window corresponding to the interface which relays communication between the host computer and the peripheral device in active in initial condition, the setting screen of the interface can be displayed preferentially to the setting screens of other interfaces. While in the second case, by arranging the setting screen corresponding to the interface which relays communication between the host computer and the peripheral device top of the pages, the setting screen of this interface can be displayed preferentially to the setting screens of other interfaces.

Furthermore, the setting screen display system may be configured to create a tab sheet which functions as setting screen for each interface and display the screen in the form of laying tab sheets of each interface, so that the setting screens for each of the interfaces are switched and displayed on the display unit, according to instructions by the user.

Optionally, the setting screen display system may be configured to switchably display the setting screen for each of the interfaces on a display unit according to an instruction from a user. The screen display controlling system may be configured to display the setting screen of one of the interfaces that relays communication between the host computer and the at least one of the peripheral device preferentially among the plurality of interfaces provided to the at least one of the peripheral device as an initially displayed screen on the setting screen display system.

According to the communication system configured as above, the setting screen for each of the interfaces is switchably displayed, which allows the user to effectively use the screen space of the display unit, and the most essential setting screen for the user may be displayed as the initial screen that may decrease switching operations of screens for the user to call up the targeted setting screen in fewer steps. Thus, operability on an operation such as configuration checking operation may be improved.

Optionally, the at least one peripheral device may include an interface connected to a wired network and an interface connected to a wireless network as the plurality of the interfaces.

In the communication system in the present invention with the peripheral device as described above, operability on an operation such as configuration checking operation may be improved in offices and organizations having mixed communication system with wired LAN and wireless LAN.

The setting screen described as above may be configured to accept an updating operation related to the configuration information stored in the storing system of the peripheral device not only being configured to simply include the configuration information stored in the storing system of the peripheral device. For example, such a setting screen can be configured as a GUI based setting screen having input objects to accept an updating operation related to the configuration information.

Optionally, the setting screen may be configured to accept an updating operation related to the configuration information being stored in the storing system of the at least one peripheral device. The host computer may comprise an update instructing system to transmit an update instruction signal to the at least one peripheral device according to an operation from the user to the setting screen displayed in a display unit by the setting screen display system, the update instruction signal being a signal to indicate updated configuration information for updating the configuration information. The at least one peripheral device may comprise a configuration updating system to rewrite the configuration information stored in the storing system according to the received instruction signal when the at least one peripheral device receives the update instruction signal from the host computer through any one of a plurality of the interfaces.

In the communication system configured as above, the preferential displaying allows the setting screen of the most essential interface for the user to update the configuration information is displayed preferentially for the user. Thus, according to the communication system, a number of times for the user to call up (a number of times for selecting windows or tabs) the targeted setting screen for a configuration operation can be reduced. Thus, operability on an configuration operation of interface (an updating operation on configuration information) may be improved.

Optionally, a screen display controlling system to display the setting screen of one of the interfaces that relays communication between the host computer and the at least one of the peripheral device preferentially among the plurality of interfaces provided to the at least one of the peripheral device on the setting screen display system may be included in the communication system. A preferential information storing system to store identification information of one of the plurality of interfaces for which setting screen is to be displayed preferentially, a preferential information updating system to update the identification information of one of the plurality of interfaces stored in the preferential information storing system with identification information of the another one of the plurality of interfaces instructed by a user, and a screen display controlling system to display the setting screen of one of the interfaces that corresponds to the identification information stored in the preferential information storing system preferentially among the plurality of interfaces provided to the at least one of the peripheral device on the setting screen display system is included in the communication system may be included in the communication system.

According to the communication system as described above, information concerning “the interface of which a setting screen is to be displayed preferentially” designated by the user is kept in the preferential information storing system, since then continuously the setting screen of the interface is displayed preferentially and allows the user to perform an operation such as configuration checking operation easily without selecting or scrolling tabs or windows for calling up the targeted setting screen each time activating the setting screen display system. Thus, operability for the user involved in the operation such as configuration checking operation may be improved.

Optionally, the preferential information storing system, the preferential information updating system, and the screen display controlling system are provided in the host computer.

According to the communication system configured as above, communication between the peripheral device and the host computer to achieve preferential display is not necessary, and the above-mentioned operability can be even more enhanced in a simple system configuration. Additionally, the “interface of which a setting screen is to be displayed preferentially” can be setup on a host computer basis, therefore, in case of connecting a plurality of host computers to the peripheral device, in every host computer individually the most essential setting screen for the user can be displayed preferentially.

Optionally, the setting screen display system may be configured to switchably display the setting screen for each of the interfaces on a display unit according to an instruction from a user, The screen display controlling system may be configured to display the setting screen of one of the interfaces that corresponds to the identification information stored in the preferential information storing system preferentially among the plurality of interfaces provided to the at least one of the peripheral device as an initially displayed screen on the setting screen display system.

The communication system configured as above enables effective use of the screen space of the display unit, and the most essential setting screen for the user is to be displayed as the initial screen, so that switching operations of screens for users to call up the targeted setting screen may be reduced. Thus, operability on operations such as configuration check operation may be improved.

According to another aspects of the invention, there is provided a peripheral device, comprising a plurality of interfaces for communicating with a host computer, a storing system to store configuration information which determines an operation of each of the interfaces, and configuration information transmission system to transmit the configuration information of one of the plurality of interfaces to the host computer issuing a request signal for the configuration information through one of the plurality of interfaces when the request signal for the configuration information from the host computer is received through one of the plurality of interfaces while the configuration information for each of the plurality of interfaces is stored in the storing system.

The peripheral device configured as above, in case of receiving the request signal of configuration information, responds with only the configuration information of the interface which received the request signal selectively among the configuration information of each of the interfaces. Meanwhile, the host computer displays the setting screen based on the received information, therefore the most essential configuration information for the user to check can be displayed selectively. Thus, according to the peripheral device, operability on an operation such as configuration checking operation may be improved.

As for application software which manages displaying the setting screen may include dedicated software, and other generally used software such as a browser. In case of displaying the setting screen for the user through the browser, the peripheral device may be configured as follows.

Optionally, the configuration information transmission system may transmit information configuring a web page, in which the configuration of the interface that received the request signal is described, while the web page is included in a setting screen to accept an updating operation related to the configuration information of the interface that received the request signal, to the host computer issuing the request signal for the configuration information through one of the plurality of interfaces when the request signal for the configuration information from the host computer is received through one of the plurality of interfaces while the configuration information for each of the plurality of interfaces is stored in the storing system. A configuration updating system to rewrite the configuration information stored in the storing system according to the received instruction signal when the peripheral device receives the update instruction signal from the host computer given by the user through the web page may be provided in the peripheral device.

According to the peripheral device configured as above, the setting screen with the configuration information is displayed in the web page form for users to view through the host computer, therefore, it is unnecessary to install any dedicated software in the host computer. Thus, the user can check the configuration information easily by using the peripheral device. Moreover, according to the peripheral device, the web page is configured to accept an updating operation related to the configuration information that improves operability on configuration operation of the interface as well as operability on a configuration checking operation.

Optionally, the web page to be transmitted by the configuration information transmission system may be provided with link information to request for a web page which is included in the setting screen related to the other interfaces than the interface corresponding to the configuration information capable of being updated through the web page included in the setting screen. The configuration information transmission system may transmit the web page included in the setting screen to accept an updating operation for updating the configuration information of the interface corresponding to the link information to the host computer issuing the request signal when the request signal transmitted according to the link information is received by the configuration information transmission system while the web page includes the configuration information for the interface corresponding to the link information.

The peripheral device configured as above may provide the user with not only the setting screen for the interface which relays communication between the host computer and the peripheral device, but also setting screens of the other interfaces as necessary in the web page form, thus operability of the peripheral device can be improved.

Optionally, the peripheral device may comprise an interface connected to a wired network and an interface connected to a wireless network as the plurality of the interfaces.

According to another aspects of the invention, there is provided a computer usable medium comprising computer readable instructions for controlling a computer having a plurality of interfaces for communicating with an external device and a storing system to store configuration information which determines an operation of each of the interfaces to execute steps of transmitting the configuration information of one of the plurality of interfaces to the external device issuing a request signal for the configuration information through one of the plurality of interfaces when the request signal for the configuration information from the external device is received through one of the plurality of interfaces while the configuration information for each of the plurality of interfaces is stored in the storing system.

According to the recording medium configured as above, the computer can be operated as the peripheral device as described above.

Optionally, the web page to be transmitted in the configuration information may be provided with link information to request for a web page which is included in the setting screen related to the other interfaces than the interface corresponding to the configuration information capable of being updated through the web page included in the setting screen, and a step to rewrite the configuration information stored in the storing system according to the received instruction signal when the computer receives the update instruction signal from the external device given by the user through the web page may be included in the steps to be executed by the computer.

According to the recording medium configured as above, the computer can be operated as the peripheral device as described above.

Optionally, the web page to be transmitted in transmitting the configuration information may be provided with link information to request for a web page which is included in the setting screen related to the other interfaces than the interface corresponding to the configuration information capable of being updated through the web page included in the setting screen. The steps executed by the computer includes transmitting the web page included in the setting screen to accept an updating operation for updating the configuration information of the interface corresponding to the link information to the external device issuing the request signal when the request signal transmitted according to the link information is received by the configuration information transmission system while the web page includes the configuration information for the interface corresponding to the link information.

### EMBODIMENTS

Hereinafter, referring to accompanying drawings, embodiments of the present invention will be described.

### First Embodiment

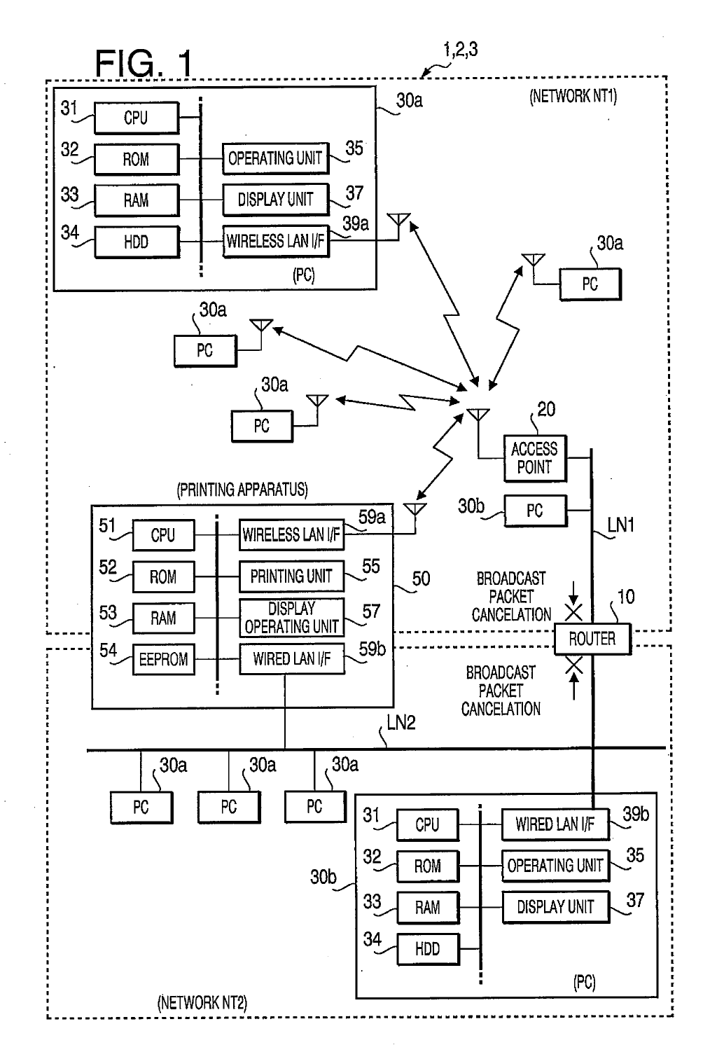

FIG. 1 is a schematic diagram showing a configuration of a communication system 1 according to a first embodiment of the present invention. As shown in FIG. 1, the communication system 1 in the present embodiment includes a first network NT1 and a second network NT2, which are interconnected via a router 10. As is well known in the art, the router 10 is for relaying communication between the first network NT1 and the second network NT2 and has a filtering function. More specifically, the router 10 has a delivery restricting function on specific packets, for example, it is configured not to relay broadcast packets to the other network. In other words, a broadcast communication which is performed in the communication system 1 according to the present embodiment is blockaded within each network NT1, NT2 separated by the router 10.

The first network NT1 is configured such that a wireless LAN access point 20 is connected to the router 10 via a LAN cable LN1. In the network NT1, a PC (personal computer) 30a, which is provided with a wireless LAN I/F (interface) 39a, and a printing apparatus 50 are connected via the wireless LAN access point 20 to be capable of communicating each other.

On the other hand, the second network NT2 is configured as a wired LAN. In the network NT2, a PC 30b, which is provided with a wired LAN I/F 39b, and the printing apparatus 50 are connected via a LAN cable LN2 to be capable of communicating each other.

Each of the PCs 30a, 30b, which is connected with the first network NT1 and the second network NT2 respectively, is provided with a CPU 31, which executes various computation, a ROM 32, which includes various programs such as a boot program, a RAM 33 as a working memory, an HDD (hard disk drive) 34, which is stored with various types of software and data such as printer driver, an operating unit 3, which includes various devices such as a keyboard and a pointing device, and a display unit 37 which includes for example an LCD (liquid crystal display) monitor. Each of the PCs 30a, 30b is operated in a multitasking OS, which is capable of displaying various windows configured by GUI (Graphical User Interface).

The PC 30a is provided with the wireless LAN I/F 39a, which is capable of communicating with a node in a wireless LAN via the wireless LAN access point 20, and the PC 30b is provide with the wired LAN IT 39b, which is capable of communicating with a node in a wired LAN via the LAN cable LN2.

Furthermore, the printing apparatus 50, which is connected to both of the first network NT1 and the second network NT2, is provided with a CPU 51, which executes various computation, a ROM 52, which includes various programs, a RAM 53 as a working memory, an EEPROM 54, which includes various configuration information, a printing unit 55, which forms images on a recording medium such as paper by a printing mechanism such as ink-jet and laser, a display operating unit 57, which is provided with various operation keys for users to be able to operate and a display unit to display information, a wireless LAN I/F 59a, which is capable of communicating with a node in a wireless LAN via the wireless LAN access point 20, and a wired LAN I/F 59b which is capable of communicating with a node in a wired LAN via the LAN cable LN2.

The printing apparatus 50 is provided with the ROM 52, which includes the programs for the CPU 51 to achieve functions as a print server, and a function as an SNMP (Simple Network Management Protocol) agent, and the CPU 51 actualizes the function as the print server, and the function as the SNMP agent by executing these programs at the time of activation. For example, upon receiving print data for printing from the external PCs 30a, 30b via the wireless LAN I/F 59a or the wired LAN I/F 59b, the CPU 51 controls the printing unit 55 to form printing images on the recording medium based on the print data.

Further, the printing apparatus 50 has communication management data DT as manageable data by SNMP in an MIB (Management Information Base) 54a of the EEPROM 54. The communication management data DT indicates configuration information related to the wireless LAN I/F 59a and the wired LAN I/F 59b.

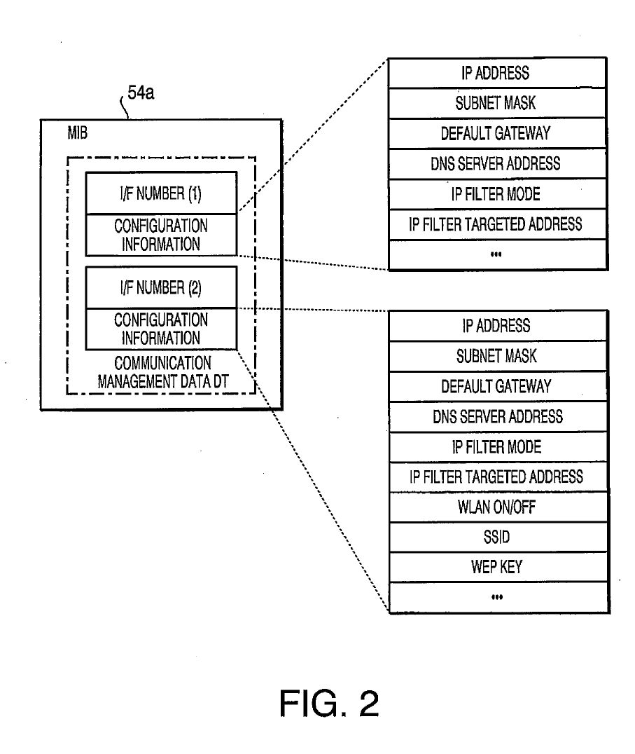

FIG. 2 is an illustrative diagram showing a configuration of the communication management data DT stored in the MIB 54a of the EEPROM 54 according to the first embodiment of the present invention, The communication management data DT describes the configuration information of each of the I/Fs 59a, 59b which is associated with I/F numbers respectively. The I/F numbers function as identification numbers of the I/Fs, and in the present embodiment, the I/F number “1” is assigned to the wired LAN I/F 59b, and the I/F number “2” is assigned to the wireless LAN I/F 59a.

The configuration information of the wired LAN I/F 59b indicated in the communication management data DT is provided with an IP address, which is uniquely set to this wired LAN I/F 59b a subnet mask, a default gateway, a DNS (Domain Name Server) address, and information of the IP filter mode and the IP filter targeted addresses.

Additionally, the printing apparatus 50 according to the present embodiment has an IP filter function, which cancels transmitting an IP packet transmitted from a specific source of an IP address to downstream tasks upon receiving the IP packet, and aforementioned information of the IP filter mode and the IP filter targeted address related to the wired LAN I/F 59b functions as information for defining the IP filter function about the IP packets received through the wired LAN I/F 59b.

Specifically, the IP filter function has an “accept” mode and a “reject” mode, and information of the IP filter mode stored in the MIB 54a indicates either of the modes between the “accept” mode or the “reject” mode which is currently set up. The information of the IP filter targeted address defines a range of source IP addresses which packets are not to be canceled or which packets are to be canceled by the IP filter function and is configured with a combination of the IP address and the subnet mask.

More specifically, when the IP filter function is set in the “accept” mode, the IP filter targeted address indicates a range of the source IP addresses of the packets which are not to be canceled by the IP filter function. For example, when the IP address of the IP filter targeted address is “aaa.bbb.ccc.ddd” and the subnet mask is “255.255.0.0”, the source IP addresses of the packets of which higher 2 bytes are “aaa.bbb” are not canceled by the IP filter function. Thus, when the IP filter function is set in the “accept” mode, and when the source IP addresses of the packets which are within a range indicated by the IP filter targeted address are delivered, these packets are transmitted to the downstream tasks without being canceled by the IP filter function, while the other received packets are canceled and not transmitted to the downstream tasks.

On the other hand, when the IP filter function is set in the “reject” mode, the IP filter targeted address indicates a range of the source IP addresses of the packets which are to be canceled by the IP filter function. For example, when the IP address of the IP filter targeted address is “aaa.bbb.ccc.ddd” and the subnet mask is “255.255.0.0”, the source IP addresses of the packets of which higher 2 bytes are “aaa.bbb” are canceled by the IP filter function. Thus, when the IP filter function is set in the “reject” mode, and when the source IP addresses of the packets which are within a range indicated by the IP filter targeted address are delivered, these packets are canceled and not transmitted to the downstream tasks by the IP filter function, while the other received packets are transmitted without being canceled.

The communication management data DT is provided with information as the configuration information of the wireless LAN I/F 59a including an IP address, which is set to this wireless LAN I/F 59a, a subnet mask, a default gateway, a DNS server address, and information of the IP filter mode and the IP filter targeted addresses, ON/OFF setup information of the wireless LAN function, and information of the SSID (Service Set ID) and an encryption key (i.e., a WEP (Wired Equivalent Privacy) key).

Similarly to the wired LAN I/F 59binformation of the IP filter mode and the IP filter targeted address of the wireless LAN IF 59a functions as information for defining the IP filter function about the IP packets received through the wireless LAN I/F 59a. Each of the I/Fs 59a, 59b provided to the printing apparatus 50 executes, in association with the CPU 51, an operation corresponding to the configuration information of the I/Fs 59a, 59b indicated in the MIB 54a respectively, and thus achieves communication unique to each I/F.

When the CPU 51 of the printing apparatus 50 receives various requests in the SNMP from the PC 30a, 30b (hereinafter, also referred to as “management PCs”), which manage the printing apparatus 50, the CPU 51 executes corresponding processes.

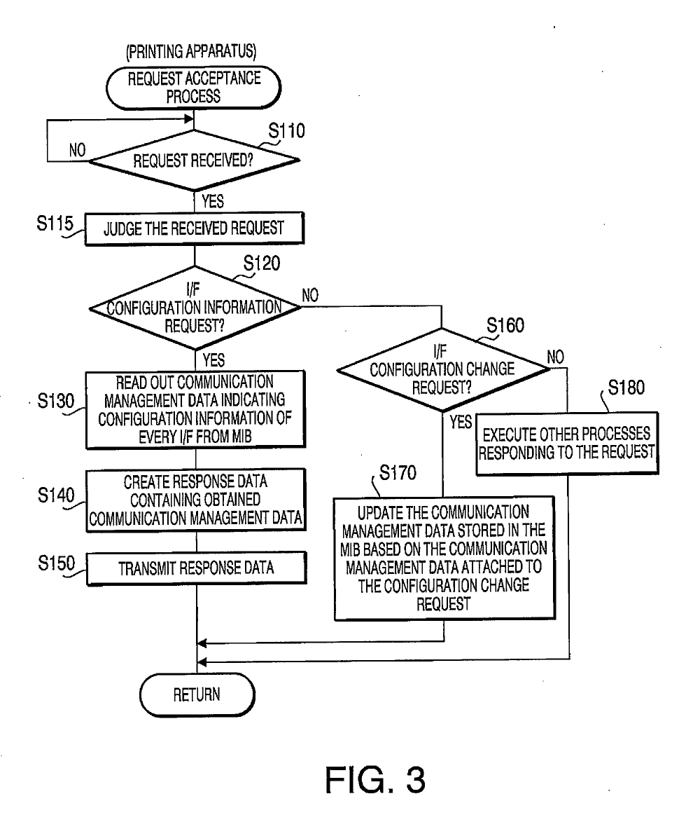

FIG. 3 is a flowchart showing a request acceptance process to be executed repeatedly by the CPU 51 of the printing apparatus 50 according to the first embodiment of the present invention. As the request acceptance process starts, the CPU 51 stands by until it receives a request transmitted from one of the management PCs 30a, 30b via the wireless LAN I/F 59a or the wired LAN I/F 59b (51O). When the CPU 51 receives any request (S110: YES), the process proceeds to S115, and identifies a type of the received request (S115).

If the received request is an I/F configuration information request for requesting configuration information of each I/F, the CPU 51 judges as YES in the following S120, and obtains the aforementioned communication management data DT, in which configuration information of respective I/Fs is written, from the MIB 54a (S130), and generates response data containing the communication management data DT (S140). Thereafter, the CPU 51 transmits the created response data (i.e., a response) to the request source, which is one of the management PCs 30a, 30b (S 150). Thereafter, the CPU 51 proceeds to 5110 and stands by until a next request is received.

If the request received in S110 is not an I/F configuration information request, but an I/F configuration change request for requesting configuration change of each I/F, the CPU 51 judges as NO in the next S120 and judges as YES in S160, and updates the communication management data DT stored in the MIB 54a based on the communication management data DT contained in the received IF configuration change request (S170). With this step, the CPU 51 updates the configuration information of each I/F. Thereafter, the process proceeds to S110 and stands by until a next request is received.

Meanwhile, if the request received in S110 is neither the I/F configuration information request nor the I/F configuration change request, the CPU 51 judges as NO in S160 and executes a process responding to the received request (S180). Thereafter, the process proceeds to S110 and stands by a next request is received.

Next, a detailed configuration of the management PCs 30a, 30b, which manage the printing apparatus 50, will be explained. In the communication system 1 according to the present embodiment, each of the first network NT1 and the second network NT2 is provided with at least one of the PCs (the management PCs) 30a, 30b having a function as an SNMP manager that is capable of managing the printing apparatus 50.

Each of the management PCs 30a, 30b stores a connection I/F number indicating one of the I/F 59a and the I/F 59b which is used for communicating with the printing apparatus 50 respectively, in the HDD 34.

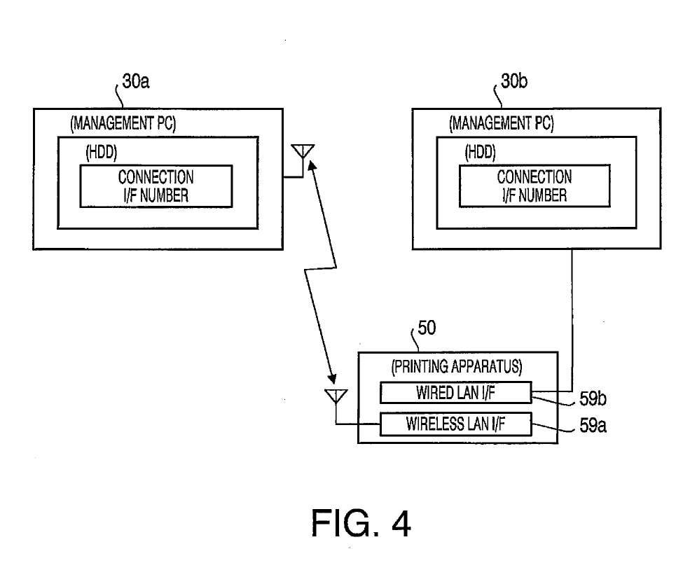

FIG. 4 is an illustrative diagram showing a storing manner of the connection interface numbers in the management PCs 30a, 30b according to the first embodiment of the present invention. The connection I/F numbers are written in each HDD 34 when a program for managing the printing apparatus 50 is installed in the PCs 30a, 30b. For example, a connection I/F number “1” is written in the HDD 34 as an initial value at the time of installation. When an instruction to display a communication configuration window WN is inputted by the user through the operating unit 35, the management PCs 30a, 30b read out the program for managing the printing apparatus 50, and the CPUs 31 of the management PCs 30a, 30b execute the communication configuration process.

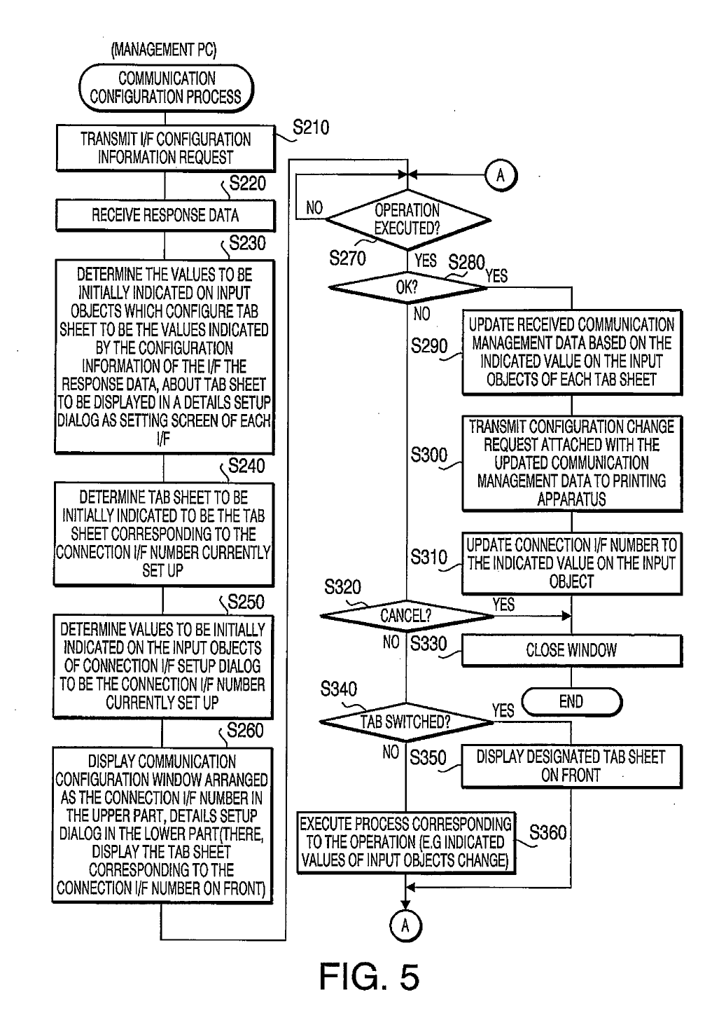

FIG. 5 is a flowchart showing a communication configuration process to be executed by the CPUs 31 of the management PCs 30a, 30b according to the first embodiment of the present invention. As the communication configuration process starts, the CPU 31 transmits an I/F configuration information request to the printing apparatus 50 via one of the wireless LAN I/F 39a and the wired LAN I/F 39b (S210) and receives the response data (a response) responding to the request (S220). In this embodiment, since a broadcast packet is canceled by the function of the router 10, the management PC 30a in the first network NT1 cannot search the printing apparatus 50 (i.e., the wired LAN I/F 59b) in the network NT2 by the SNMP packet (the broadcast packet), while the management PC 30b in the second network NT2 cannot search the printing apparatus 50 (i.e., the wireless LAN I/F 59a) in the first network NT1 by the SNMP packet (the broadcast packet). Therefore, in the present embodiment, the I/F configuration information request is not transmitted from the management PC 30a in the first network NT1 to the printing apparatus 50 via the second network NT2. Similarly, the I/F configuration information request is not transmitted from the management PC 30b in the second network NT2 to the printing apparatus 50 via the first network NT1. This means, the respective PCs 30a,30b communicate with the printing apparatus 50 within the network to which each of the PCs 30a, 30b belongs (i.e., the first network NT1 or the second network NT2) in S210-S220.

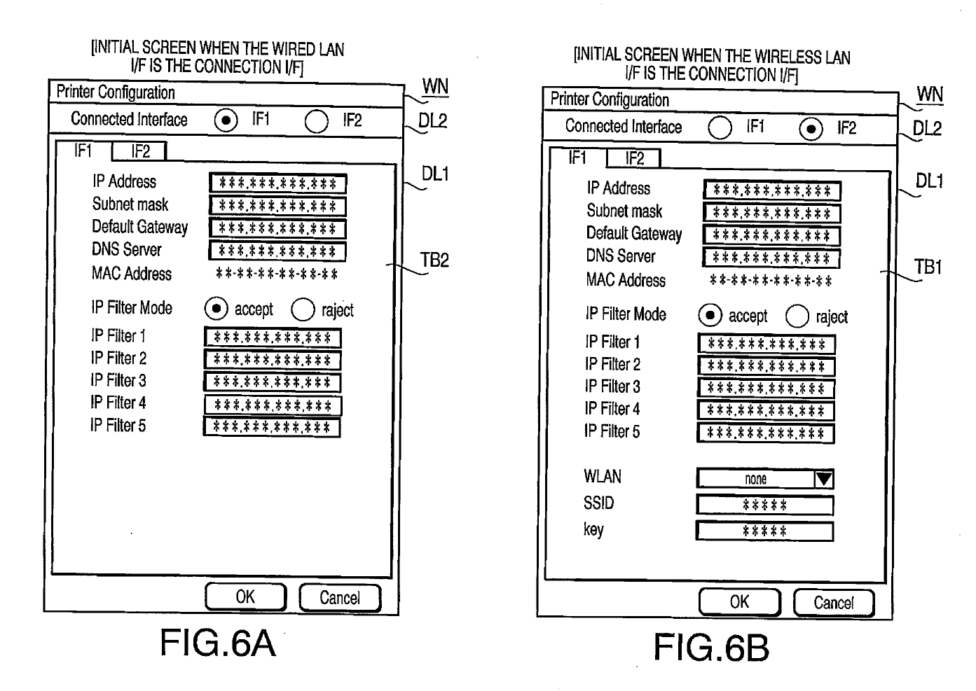

Following S220, the CPU 31 determines a values to be initially indicated on each input object (e.g. a text box, a radio button, and a pull-down menu) in tab sheets TB1, TB2 (see FIGS. 6A, 6B), which serve as setting screens for each of the wireless LAN I/F 59a and the wired LAN 59b (S230). In this step, the values of communication management data DT, which are contained in the response data, are determined to be the values to be initially indicated in the input objects.

FIGS. 6A, 6B are illustrative diagrams showing a communication configuration window WN according to the first embodiment of the present invention. As shown in FIGS. 6A, 6B, the communication configuration window WN displayed in response to a display instruction as described above on the display unit 37 in 260 has the tab sheets TB1, TB2 for each of the wireless LAN I/F 59a and the wired LAN I/F 59b respectively in a details setup dialog DL.

Following S230, the CPU 31 proceeds to S240 and determines the tab sheet (either the tab sheet TB1 for the wireless LAN I/F 59a or TB2 for the wired LAN I/F 59b) that is to be initially shown on front in the details setup dialog DL1. In this step, the tab sheet corresponding to the connection I/F number which is currently set up (i.e., the connection I/F number stored in the HDD34) is determined to be the tab sheet to be initially shown on front.

Following S240, the CPU 31 determines values to be initially indicated in the input objects, which are included in a connection I/F setup dialog DL2 and arranged in an upper part of the communication configuration window WN. In this step, the connection I/F number that is currently set up in the HDD34 is determined to be the values to be initially indicated in the input objects (S250). Specifically, if the input objects are radio buttons, the values to be initially indicated on the input objects are determined to be the connection I/F number that is currently set up by specifying in S250 the radio button that corresponds to the connection I/F number currently being set up.

Thereafter, the CPU 31 proceeds to S260 and displays the communication configuration window WN on the display unit 37 with the connection I/F setup dialog DL2 in the upper and the details setup dialog DL1 in the lower part. The connection I/F setup dialog DL2 is configured to accept an updating operation for the connection I/F number from the user, and the details setup dialog DL1 is provided with the tab sheets TB1, TB2 for the wireless LAN I/F 59a and the wired LAN I/F 59b respectively. The tab sheets TB1, TB2 are configured to accept an updating operation for the configuration information of I/Fs from the user. In this step, according to the determination as described above, the CPU 31 displays the details setup dialog DL1 in the communication configuration window WN with the tab sheet of the I/F which corresponds to the connection I/F number being laid on front.

In S260, when a connection I/F number stored in the HDD 34 indicates the wired LAN I/F 59b for example, the CPU 31 displays the communication configuration window WN as shown in FIG. 6A on the display unit 37.

Specifically, the connection I/F setup dialog DL2 with the radio button “IF1” which corresponds to the wired LAN I/F 59b being specified and the other radio button “IF2” which corresponds to the wireless LAN I/F 59a, being left unspecified is displayed in the upper part of the communication configuration window WN.

Additionally, the details setup dialog DL1 with the tab sheet TB2 for setting up the wired LAN I/F 59b being laid on front is displayed in the lower part of the communication configuration window WN. The tab sheet TB 2 includes text boxes for setting the IP address, the subnet mask, the default gateway, and the DNS address, the MAC address of the wired LAN I/F 59b the radio buttons for setting the IP filter mode, and other text boxes for setting the IP filter targeted addresses, which indicate the currently setup values related to the wired LAN I/F 59b,.

In S260, when a connection I/F number stored in the HDD 34 indicates the wireless LAN I/F 59a, the CPU 31 displays the communication configuration window WN as shown in FIG. 6B on the display unit 37.

Specifically, the connection I/F setup dialog DL2 with the radio button “IF1” which corresponds to the wired LAN I/F 59b being left unspecified and the other radio button “IF2” which corresponds to the wireless LAN I/F 59a being specified is displayed in the upper part of the communication configuration window WN.

Additionally, the details setup dialog DL1 with the tab sheet TB1 for setting up the wireless LAN I/F 59a being laid on front is displayed in the lower part of the communication configuration window WN. The tab sheet TB1 includes text boxes for setting the IP address, the subnet mask, the default gateway, and the DNS address, the MAC address of the wireless LAN I/F 59a, the radio buttons for setting the IP filter mode, and other text boxes for setting the IP filter targeted addresses, a pull-down menu for setting ON/OFF of the wireless LAN function, and text boxes for setting SSID and the WEP key which indicate the currently setup values related to the wireless LAN I/F 59a.

Following S260, the CPU 31 proceeds to S270 and stands by until an operation to the communication configuration window WN from the user through the operating unit 35 is executed. When the operation is executed (S270: YES), the CPU 31 judges as to whether the operation was pressing operation of an “OK” button for transmitting the I/F configuration change request arranged in a bottom part of the communication configuration window WN (S280), and if it is judged that the pressing operation of “OK” button (8280: YES), the process proceeds to S290. If it is judged that the operation was not the pressing operation of “OK” button (S280: NO), the process proceeds to S320.

In S290, the CPU 31 updates each value indicated in the received communication management data DT to the value set in the input objects in one of the tab sheets TB1 and TB2 in the details setup dialog DL1. Thus, by transmitting the I/F configuration change request with the updated communication management data DT to the printing apparatus 50, the configuration information of each I/F provided in the printing apparatus 50 is updated (S300).

Following S300, the CPU 31 proceeds to S310 and updates the connection I/F number stored in the HDD 34 to the value set in the input objects in the connection I/F setup dialog DL2. Thus, the CPU 31 executes configuration change of the connection I/F number by this operation. Thereafter, the CPU 31 proceeds to S330.

On the other hand, in S320, the CPU 31 judges as to whether the operation to this communication configuration window WN was pressing operation of “Cancel” button arranged in the bottom part of the communication configuration window WN, and if it is judged that the operation was a pressing operation of “Cancel” button (S320: YES), the CPU 31 proceeds to S330. Thus, in S330, the CPU 31 closes the displayed communication configuration window WN, and terminates this communication configuration process.

In S320, if it is judged that the operation to the communication configuration window WN was not the pressing operation of “Cancel” button (S320: NO), the CPU 31 proceeds to S340 and judges as to whether the executed operation was the display switching operation of the tab sheets TB1, TB2. If the executed operation is judged to be the display switching operation of the tab sheets TB1, TB2 (S340: YES), the CPU 31 updates the screen of the details setup dialog DL1 through the operating unit 35, so that the tab sheet TB, which is designated by the user to be displayed on front (S350). Thereafter, the process proceeds to S270.

In addition, in S340, if it is judged that the executed operation was not the display switching operation of the tab sheets TB1, TB2 (S340: NO), the CPU 31 executes a process which corresponds to the operation executed on this communication configuration window WN (S360). Specifically, if the input objects were modified, the values indicated by the input objects (values set in the input objects) are changed according to the modification. Thus, after the end of the process in S360, the process proceeds to S270.

Hereinabove, the communication system 1 in the first embodiment has been described. According to this communication system 1, the printing apparatus 50 is provided with a plurality of I/Fs 59a, 59b and stores the configuration information which determines the operation of each I/F in the MIB 54a. When the printing apparatus 50 receives the I/F configuration information request from one of the management PCs 30a, 30b via either of I/Fs 59a, 59b the printing apparatus 50 reads out the communication management data DT which indicates configuration information of each I/F stored in the MIB 54a, and transmits the data to the request source, one of the management PCs 30a and PC 30b via either of I/F 59a or I/F 59b which was applied to receive the request in S150.

Meanwhile, when the display instruction of the communication configuration window WN is inputted by the user through the operating unit 35, one of the management PCs 30a, 30b transmits the I/F configuration information request to the printing apparatus 50, while receives the communication management data DT as the response data from the printing apparatus 50. Following the process, one of the tab sheets TB1 and TB2 is displayed of each I/F switchably according to the instruction of the user on the details setup dialog DL1 in S230-S260 process, wherein one of the tab sheets TB1 and TB2 includes the configuration information of each I/F that is stored in the MIB 54a of the printing apparatus 50 based on the received communication management data DT, and the configuration information of each I/F stored in the MIB 54a is acceptable of updating operation by one of the tab sheets TB1 and TB2 of each I/F.

Additionally, each of the management PCs 30a, 30b according to the first embodiment stores the connection I/F numbers in the HDD 34 as identification information of the I/F for the tab sheets TB1, TB2 to be displayed preferentially, and updates the connection I/F numbers stored in the HDD 34 to the I/F number instructed by the user through the connection I/F setup dialog DL2. Further, in S250, by determining the tab sheet TB1 or TB2 for the I/F corresponding to the connection I/F numbers stored in the HDD 34 to be the tab sheet TB1 or TB2 which is to be initially displayed on front, the tab sheet TB1 or TB2 which corresponds to the I/F instructed by the user among a plurality of I/Fs 59a, 59b provided in the printing apparatus 50 is displayed preferentially on the details setup dialog DL1, in S260.

Furthermore, the management PCs 30a, 30b change the setup values (indicated values) of the input objects according to the operation to the tab sheets TB1, TB2 by the user, and if the “OK” button is pressed, the management PCs 30a, 30b change each value of the communication management data DT to the value corresponding to the changed setup value of the input objects, and transmit them with the I/F configuration change request to the printing apparatus 50. Therefore, the management PCs 30a, 30b update the communication management data UT stored in the MIB 54a(the configuration information of each of the I/Fs). Specifically, when the printing apparatus 50 receives the I/F configuration change request from one of the management PCs 30a and 30b via either the wireless LAN I/F 59a or the wired LAN I/F 59b (S160: YES), the printing apparatus 50 rewrites the communication management data DT stored in the MIB 54a based on the communication management data DT contained in the request.

Thus, the communication system 1 according to the first embodiment displays the setting screen of I/F (i.e., the tab sheet TB1 or TB2) which is designated by the user among the setting screens of each I/F (the tab sheet TB1 or TB2) which can be checked and change the configuration information preferentially on the communication configuration window WN, therefore, the user can conduct operations such as configuration check operation and configuration change operation easily without a selecting operation of the tab for calling up a desired I/Fs tab sheet each time calling up the communication configuration window WN by designating the I/F, which is used frequently for configuration check and configuration change. Thus, the communication system 1 according to the present embodiment enhances operability for the users involved in the operations such as configuration check operation and configuration change operation.

In the present embodiment, the I/F to be accessed by the management PCs 30a, 30b, which is one of the wireless LAN I/F 59a and the wired LAN I/F 59b equipped to the printing apparatus 50, is assumed to be designated by the user as the connection I/F. When such designation is given, a tab sheet related to the I/F that relays communication between the management PCs 30a, 30b and the printing apparatus 50 is displayed preferentially in the details setup dialog DL1.

Additionally, in the present embodiment, the communication system 1 is enabled set a connection I/F number for each management PC 30a and PC 30b, therefore, in case of managing the printing apparatus 50a with plurality of PCs 30a, 30b, the most essential screen (the tab sheet TB1 or TB2) can be displayed for each management PC 30a and PC 30b preferentially.

Thus far, in the present embodiment, the communication system 1 wherein the connection I/F is designated by the user has been described, however, the communication system 1 also may be configured such that the I/F relays communication between the management PCs 30a, 30b, and the printing apparatus 50 is detected automatically so that the tab sheet TB1 or TB2 related to the I/F may be displayed preferentially in the details setup dialog DL1.

### Second Embodiment

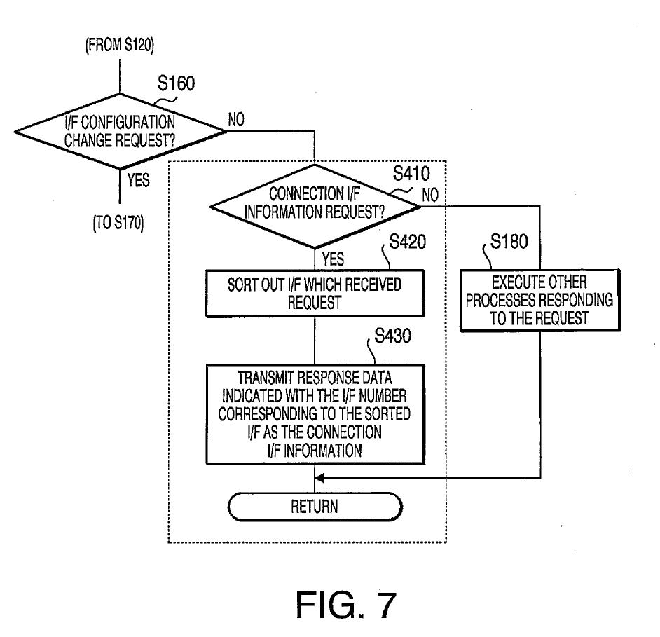

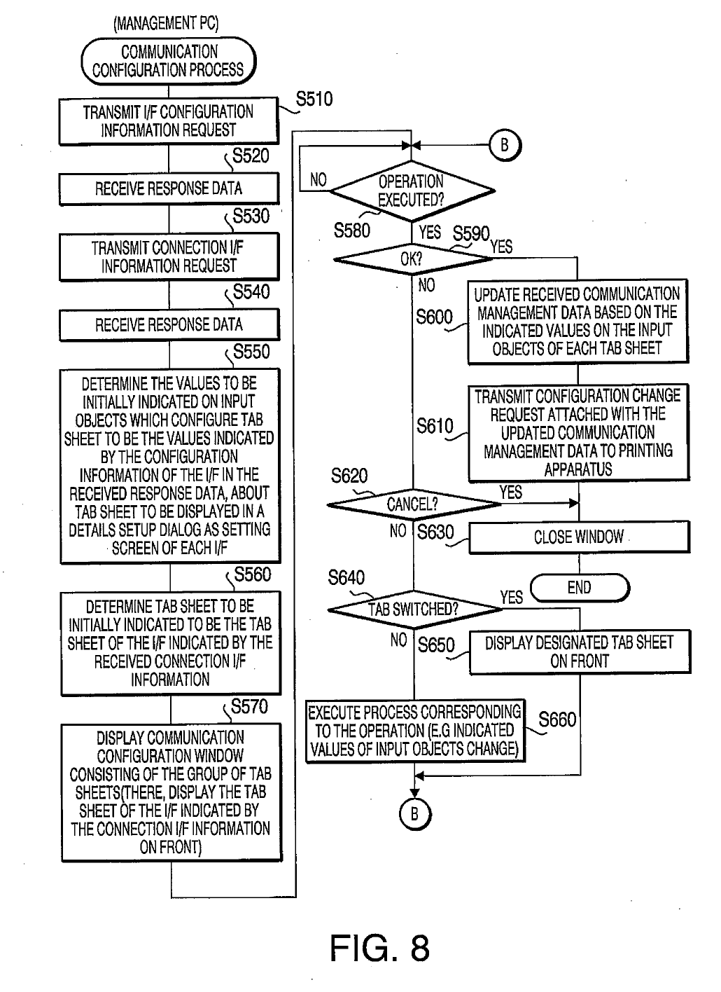

FIG. 7 is a flowchart showing a request acceptance process to be executed repeatedly by a CPU 51 of a printing apparatus 50 in a communication system 2 according to a second embodiment of the present invention. FIG. 8 is a flowchart showing a communication configuration process to be executed by a CPU 31 of management PCs 30a , 30b in the communication system 2 according to the second embodiment of the present invention.

The communication system 2 in the present embodiment has similar configuration to the communication system 1 in the previous embodiment except that the connection I/F numbers are not stored in the HDD 34 in the management PCs 30a, 30b, the operations in the request acceptance process which are executed by the CPU 51 in the printing apparatus 50 differ from those in the previous embodiment. Further, the operations in the communication configuration process which are executed by the CPU 31 in the management PCs 30a, 30b differ from that in the previous embodiment. It should be noted that in the present and the following embodiments, a configuration of the communication system which is similar to the configuration of the previous embodiment is referred to by an identical reference numeral, and description of that will be omitted.

Referring to FIG. 7, a request acceptance process which is executed by the CPU 51 in the printing apparatus 50 will be described. The request acceptance process according to the second embodiment is provided with steps indicated by a dotted frame in FIG. 7 on the flow path in-between S160 and S180 shown in FIG. 3.

Specifically, as the request acceptance process starts, the CPU 51 executes the process of S110-S170, which are similar to those in the request acceptance process in the first embodiment. If the received request is neither an I/F configuration information request nor an I/F configuration change request, the CPU 51 judges as NO in S160, and the process proceeds to S410.

In S410, the CPU 51 judges as to whether the received request is a connection I/F information request for requesting information of the I/F, which relays communication between the request source and the printing apparatus 50. If the CPU 51 judges that the received request is a connection I/F information request (S410: YES), the process proceeds to S420. On the other hand, if the CPU 51 judges that the received request is not a connection I/F information request (S410: NO), the CPU 51 executes the process in S180, and the process proceeds to S110.

In S420, the CPU 51 determines the I/F that received the connection I/F information request from the wireless LAN I/F 59a and the wired LAN I/F 59, and terminates the process, then creates response data containing the I/F number which is assigned to the determined I/F as the a connection I/F information in 8430. Also in 8430, the created response data (a response) is transmitted to the request source, the management PCs 30a, 30b via the I/F that received the connection I/F information request, and thereafter, the process proceeds to S110.

Next, referring to FIG. 8, a communication configuration process which is executed by the CPU 31 of the management PCs 30a, 30b according to the second embodiment will be described. As the communication configuration process starts, first, the CPU 31 transmits the I/F configuration information request to the printing apparatus 50 via one of the wireless LAN I/F 39a and the wired LAN I/F 39b (S510), and receives the response data (the response) to the request from the printing apparatus 50 (S520). Following S520, the CPU 31 transmits the connection I/F information request to the printing apparatus 50 via one of the wireless LAN I/F 39a and the wired LAN I/F 39b (S530), and receives the response data which contains aforementioned connection I/F information as the response data to the request (S540).

Following S540, the CPU 31 determines values to be initially indicated in the input objects, which are respectively included in the aforementioned tab sheet TB1, TB2. In this step, the values which are indicated in the communication management data DT contained in the received response data is determined to be the values to be initially indicated in the input objects (S550). Thereafter, as the CPU 31 determines the tab sheet TB1 or TB2 for the wireless LAN I/F 59a and the wired LAN I/F 59b to be the tab sheet TB1 or TB2 which is to be initially displayed on front in the details set up dialog DL1, the tab sheet TB1 or TB2 which corresponds to the I/F number which is indicated in the response data received in S540 as the connection I/F information (S560).

Following S560, the CPU 31 proceeds to S570 and displays the communication configuration window WN having the details setup dialog DL1, which includes the tab sheets TB1, TB2 for each I/F which is adapted to accept an updating operation of the configuration information, on the display unit 37 as shown in FIGS. 6A, 6B. In this case, the details setup dialog DL1 is displayed on the communication configuration window WN according to the determinations above, wherein the details setup dialog DL1 is provided with the tab sheet TB1 or TB2 for the I/F corresponding to the I/F number, which is indicated by the connection I/F information, is displayed on front. However, unlike the first embodiment, the connection I/F setup dialog DL2 is not displayed in the communication configuration window WN in the present embodiment. In other words, the communication configuration window WN of the present embodiment is displayed without the connection I/F setup dialog DL2 on the display unit 37.

Following S570, the CPU 31 proceeds to S580, and stands by until any operation to the communication configuration window WN through the operating unit 35 is executed. When the operation is executed (S580: YES), the CPU 31 judges as to whether the operation was a pressing operation of “OK” button for the I/F configuration change request transmission that is arranged in a bottom part of the communication configuration window WN (8590), and if it is judged that the operation was the pressing operation of “OK” button (S590: YES), the process proceeds to S600. On the other hand, if it is judged that the operation was not the pressing operation of “OK” button (S590: NO)) the process proceeds to S620.

In S600, the CPU 31 updates each indicated value of the received communication management data DT to the value set in the input objects including tab sheets TB1 and TB2 of the details setup dialog DL1, and transmits the I/F configuration change request with the updated communication management data DT to the printing apparatus 50, the configuration information of each I/F provided in the printing apparatus 50 is updated (S610). Thereafter, the process proceeds to S630.

En S620, the CPU 31 judges as to whether an operation on this communication configuration window WN was the pressing operation of “Cancel” button provided in the bottom part of the communication configuration window WN, and if it is judged that the operation was the pressing operation of “Cancel” button (S620: YES), the process proceeds to S630. In S630, the CPU 31 closes the displayed communication configuration window WN, and terminates the communication configuration process.

On the other hand, in S620, if the operation on the communication configuration window WN is judged not to be the pressing operation of “Cancel” button (S620: NO), the CPU 31 proceeds to S640, and judges as to whether the executed operation was a display switching operation of the tab sheets TB1, TB2. If the executed operation is judged to be the display switching operation of the tab sheets TB1, TB2 (S640: YES), the CPU 31 updates the screen of the details setup dialog DL1 through the operating unit 35, so that one of the tab sheets TB 1 and TB2 which is designated by the user to be displayed on front (S650). Thereafter, the process proceeds to S580.

Meanwhile, if the aforementioned operation is judged not to be the display switching operation of the tab sheets TB1, TB2 (S640: NO), similarly to the process in S360, the CPU 31 executes a process which corresponds to the operation executed on the communication configuration window WN (S660). Thereafter, the process proceeds to S580.

Hereinabove, the communication system 2 in second embodiment has been described. According to the communication system 2, when the printing apparatus 50 receives the connection I/F information request, the CPU 51 determines the I/F that received the request (S420), and responds accompanying the determined I/F number to the request source, (i.e., the management PCs 30a, 30b), and thereafter displays preferentially the setting screen (i.e., the tab sheet TB1 or TB2) of the I/F which relays communication to the printing apparatus 50 on the request source (i.e., the management PCs 30a, 30b) in the details setup dialog DL1.

Since the setting screen (i.e., the tab sheet TB1 or TB2) which relates communication with the management PCs 30a, 30b as the operation objects and the printing apparatus 50 may be considered the most essential screen for the user operating the management PCs 30a, 30b, displaying the tab sheet of the I/F that relays the communication with the management PCs 30a, 30b and the printing apparatus 50 preferentially, like the communication system 2 according to the present embodiment, can reduce operation steps for the display switching operation of the tab sheets TB1, TB2 required for configuration check and configuration change operations than in a conventional configuration. Thus, the communication system 2 according to the present embodiment enhances operability for users involved in the operations such as configuration check operation and configuration change operation.

Additionally, in the aforementioned embodiment, it is necessary to install a dedicated software in the PCs 30a, 30b to achieve the communication configuration process, however, by installing a web sever function in the printing apparatus 50 instead, a similar function to the aforementioned communication system 2 can be achieved without installing the dedicated software in the PCs 30a, 30b. An example of such a configuration will be described in the following embodiment.

### Third Embodiment

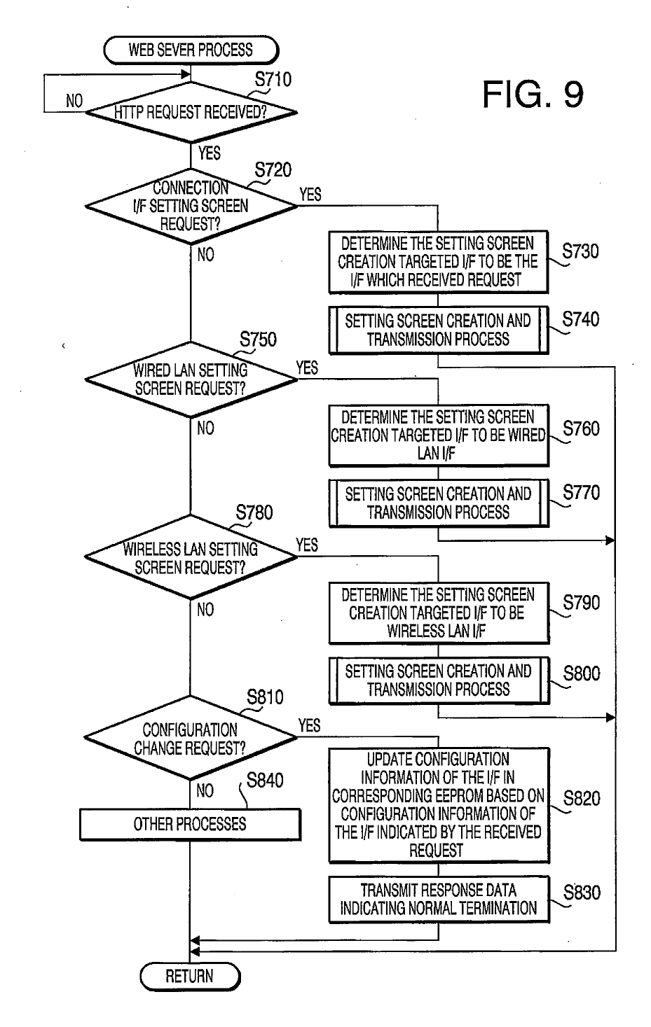

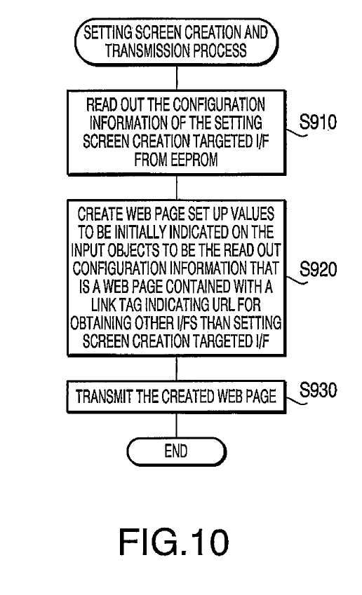

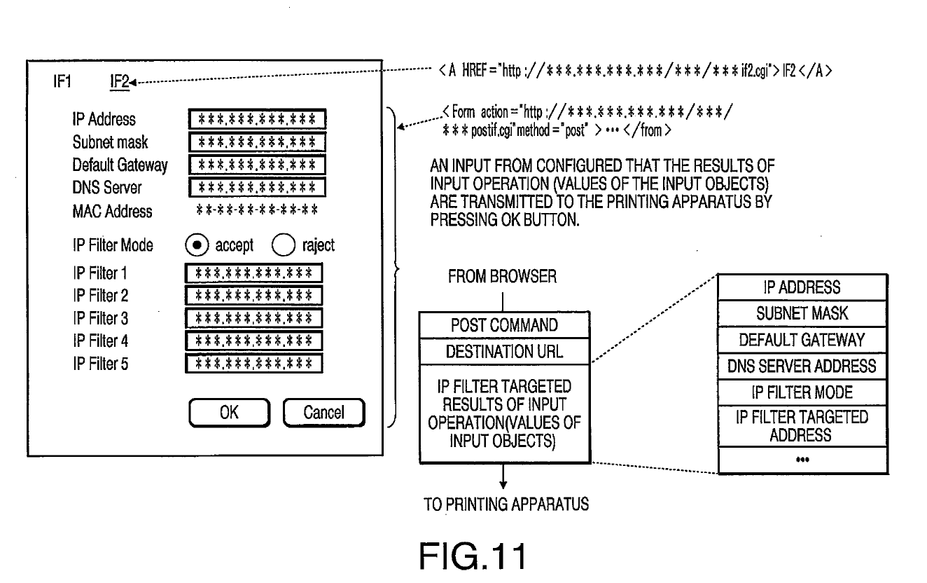

Next, referring to FIG. 9, a web server process executed by a CPU 51 of a printing apparatus 50 according to a third embodiment of the invention will be described. FIG. 9 is a flowchart showing the web server process to be executed repeatedly by the CPU 51 of the printing apparatus 50 according to the third embodiment of the invention. FIG. 10 is a flowchart showing a setting screen creation transmission process to be executed by the CPU 51 of the printing apparatus 50 according to the third embodiment of the invention. FIG. 11 is an illustrative diagram showing a configuration of a web page to be transmitted in the web server process according to the third embodiment of the invention.

The communication system 3 according to the third embodiment has a system configuration as shown in FIG. 1, similarly to the aforementioned first embodiment and the second embodiment. Additionally, a characteristic unique to the present embodiment is that software called “browser” being capable of displaying a web page correctly is included in each PC 30a and 30b which fractions as a management PC.

Further, the printing apparatus 50 according to the present embodiment has a program which allows the printing apparatus 50 to function as a web sever in the ROM 52 so that the CPU 51 controls the printing apparatus 50 as a web sever by executing the program. As for the rest, in the third embodiment, the user (an administrator) of the management PCs 30a, 30b is informed of a URL (Uniform Resource Locator) concerning the web page which configures the connection VIP setting screen being mentioned hereinafter.

Specifically, in the communication system 3 according to the third embodiment, when the user of the management PCs 30a, 30b designates the aforementioned URL and inputs a web page acquisition command in the browser, an HTTP (Hyper Text Transport Protocol) request for requesting the web page which configures the connection I/F setting screen is transmitted from the management PCs 3Oa, 30b to the printing apparatus 50.

When the printing apparatus 50 receives the request, the CPU 51 processes the request by the web sever process shown in FIG. 9. Thus, the printing apparatus 50 executes the aforementioned web server process in the CPU 51 repeatedly immediately after activation.

When the web sever process starts according to the program stored in the ROM 52, the CPU 51 stands by until it receives an HTTP request (GET request or POST request) transmitted externally via one of the wireless LAN I/F 59a or the wired LAN I/F 59b (S710). If the CPU 51 received any HTTP request, it judges as to whether the received HTTP request is for requesting the web page which configures the connection I/F setting screen (S720).

In this step, if the received HTTP request is judged to be the aforementioned request concerning the web page, which configures the connection I/F setting screen (S720: YES), the CPU 51 proceeds to S730 and determines that one of the wireless LAN I/F 59a and the wired LAN I/F 59b which received the aforementioned HTTP request is a setting screen creation object I/F and executes a setting screen creation process as shown in FIG. 10 (S740).

When the setting screen creation process starts, the CPU 51 reads out the configuration information of the I/F, which was determined to be the setting screen creation object I/F, from an EEPROM 54 (S910), and based on the configuration information, the CPU 51 creates the web page that includes the setting screen to accept an updating operation of the configuration information of the I/F, which was determined to be the setting screen creation object I/F (S920).

Specifically, in S920, the CPU 51 creates the web page as shown in FIG. 11 The web page shown in FIG. 11 is a web page to be created when the setting screen creation object I/F is the wired LAN I/F 59b.

More specifically, when the setting screen creation object I/F is the wired LAN I/F 59b the CPU 51 creates a web page for setting the wired LAN I/F 59b in 920, wherein each text box for setting an IP address set up with the currently setup value indicated as the configuration information of the wired LAN I/F 59b as the initial value (the indicated value), the subnet mask, the default gateway, the DNS address, and the MAC address of the wireless LAN I/F 59a, the radio buttons for setting the IP filter mode set up with the currently setup mode as the initial value, and other text boxes for setting the IP filter targeted addresses set up with the current IP filter targeted addresses as the initial values are provided.

Additionally, in case of creating the web page, an “OK” button that enables transmitting the POST request (hereinafter, also referred to as “the configuration change request”) including the value set up in each of the aforementioned input objects (e.g. text box, radio button) is added in the bottom part of the web page. Further, a “Cancel” button which enables resetting the value set up in each of the input objects included in the web page to the initial value is added in the bottom part of the web page.

Furthermore, in case of creating the web page, a character string “IF1 ” which indicates that the current web page is for setting the wired LAN I/F 59band link information (link tag) concerning the web page included in the setting screen (the wireless LAN setting screen) for the other I/F (i.e., the wireless LAN I/F 59a) being incapable of setting within the web page are added in the top part of the web page. Thus, the CPU 51 creates the web page shown in FIG. 11, when the setting screen creation object I/F is the wired LAN I/F 59b.

On the other hand, when the setting screen creation object I/F is the wireless LAN I/F 59a, the CPU 51 creates a web page for setting the wireless LAN I/F 59a in 920, wherein each text box for setting an IP address set up with the currently setup value indicated as the configuration information of the wireless LAN I/F 59a as the initial value (the indicated value), the subnet mask, the default gateway, the DNS address, and the MAC address of the wireless LAN I/F 59a, the radio buttons for setting the IP filter mode set up with the currently setup mode as the initial value, and other text boxes for setting the IP filter targeted addresses set up with the current IP filter targeted addresses as the initial values, a pull-down menu for setting ON/OFF for the wireless LAN function set up with the currently setup mode as the initial value, and each text box for setting SSID and the WEP key are provided.

Other than those above, in case of creating the web page, similarly to the case that the setting screen creation object I/F is the wired LAN I/F 59b an “OK” button for the configuration change request transmission, and an “Cancel” button for reset are added in the bottom part of the web page. Also in case of creating the web page, a character string “IF2” which indicates that the current web page is for setting the wireless LAN I/F 59a, and link information (link tag) concerning the web page included in the setting screen for the other I/F (i.e. the wired LAN I/F 59b) being incapable of setting within the web page are added in the top part of the web page. Thus, the CPU 51 creates the web page having a similar form to the details setup dialog DL1 shown in FIG. 6B, when the setting screen creation object I/F is the wireless LAN I/F 59a.

Meanwhile, following S920, the CPU 31 proceeds to S930, and transmits the aforementioned created web page to the request source, that is the management PCs 30a, 30b, via the I/F that received the request. Thereafter, the CPU 31 terminates the setting screen creation transmission process.

Thus, in this way, following the setting screen creation transmission process in S740, the CPU 51 proceeds to S710 and stands by until it receives the next transmitted HTTP request. Subsequently, if the CPU 51 judges that the received HTTP request was not the aforementioned request concerning the web page included in the connection I/F setting screen (S720: NO), the CPU 51 proceeds to S750, and judges as to whether the received HTTP request is for requesting the web page included in the wired LAN setting screen. The request is transmitted from the management PCs 30a, 30b based on one of the link information added to the web page included in the connection I/F setting screen and the link information added to the web page included in the wireless LAN setting screen.

In S750, if the received HTTP request is judged to be the aforementioned request concerning the web page included in the wired LAN setting screen (S750: YES), the CPU 51 proceeds to S760, and sets the setting screen creation object I/F to the wired LAN I/F 59b. Thereafter, in S770, the CPU 51 executes the setting screen creation process as described above (see FIG. 10), so that the configuration information related to the wired LAN I/F 59b is indicated, and the web page included in the wired LAN setting screen to accept an updating operation related to the configuration information is transmitted to the request source, that is the management PCs 30a, 30b. Thereafter, the CPU 51, proceeds to S710.

If the received HTTP request is judged not to be the aforementioned request concerning the web page included in the wired LAN setting screen (S750: NO), the CPU 51 proceeds to S780, and judges as to whether the received HTTP request is for requesting the web page included in the wireless LAN setting screen. The request is transmitted from the management PCs 30a, 30b based on one of the link information added to the web page included in the connection I/F setting screen and the link information added to the web page included in the wired LAN setting screen.

In S780, if the received HTTP request is judged to be the aforementioned request concerning the web page included in the wireless LAN setting screen (S780: YES), the CPU 51 proceeds to S760, and sets the setting screen creation object I/F to the wireless LAN I/F 59a. Thereafter in S800, the CPU 51 executes the setting screen creation process as described above (see FIG. 10), so that the configuration information related to the wireless LAN I/F 59a is indicated, and the web page included in the wireless LAN setting screen to accept an updating operation related to the configuration information is transmitted to the request source, that is the management PCs 30a, 30b. Thereafter, the CPU 51, proceeds to S710.

Yet more, if the received HTTP request is judged not to be the aforementioned request concerning the web page included in the wireless LAN setting screen (S780: NO), the CPU 51 proceeds to S810, and judges as to whether the received HTTP request is the configuration change request transmitted from the management PCs 30a, 30b according to the pressing operation of “OK” button.

If the received HTTP request is judged to be the aforementioned configuration change request (S810: YES), the CPU 51 updates the configuration information of the corresponding I/F that is stored in the EEPROM 54, based on the aforementioned setup values of the input objects indicated by the request. In the configuration change request, as well as the setup values of the input objects, the I/F number indicating the configuration information of the object of updates is included. Such an operation is achieved by writing the I/F number related to the setting screen creation object I/F to the web page as hidden data in the process in S920. Thereafter, the CPU 51 proceeds to S830, then transmits response data (a response) informing normal termination of the configuration change to the request source, that is the management PCs 3Oa, 30b. Thereafter, the process proceeds to S710.

If the received HTTP request is judged not to be the aforementioned configuration change request (S810: NO), the CPU 51 proceeds to S840, and executes other processes corresponding to the received request. Thereafter, the process proceeds to S710.

Hereinabove, the communication system 3 in the third embodiment has been described. According to the communication system 3, when the printing apparatus 50 received the predetermined HTTP request from the management PCs 30a, 30b, the printing apparatus 50 sets up each parameter value indicated in the configuration information of the I/F that received the HTTP request among the configuration information of each the I/F 59a and I/F 59b stored in the EEPROM 54, as the initial value (the indicated value) for the configuration information updating operation, and creates a web page included in the setting screen of the I/F to accept an updating operation. Thereafter, the printing apparatus 50 transmits the created web page to the request source, that is the management PCs 30a, 30b.

Also, when the printing apparatus 50 receives the aforementioned configuration change request, which is an instruction to update the configuration information from the management PCs 30a, 30b, from the user through the web page, the printing apparatus 50 updates the configuration information of the I/P stored in the EEPROM 54 according to the setup values of the input objects.

Thus, the communication system 3 according to the third embodiment, the setting screen indicating the current configuration information for the updating operation is displayed in the web page, it is unnecessary to install any dedicated software in the PCs 30a, 30b to display the setting screen. Therefore, the user can operate configuration check and configuration change on each of the I/Fs 59a, 59b easily by using the printing apparatus 50.

Further, according to the third embodiment, the most essential setting screen of I/F for the connection I/F can be displayed on each of the management PCs 30a and PC 30b preferentially between each setting screen on the wireless LAN I/F 59a and the wired LAN I/F 59b therefore the user can display the setting screen related to the object I/F for configuration check and change on the display unit 37 by only transmitting the request from the management PCs 30a, 30b without designating the I/F. Thus, the communication system 3 according to the present embodiment can improve operability on configuration check and configuration change.

Although examples of carrying out the invention have been described, those skilled in the art will appreciate that there are numerous variations and permutations of the communication system that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims. For example, although in the third embodiment, an equivalent process to the communication system 2 in the second embodiment is achieved by using the web sever function, an equivalent process to the communication system 1 in the first embodiment may be also achieved by using the web sever function.

Additionally, although the communication system has been described relating to a printing apparatus 50 having the wireless LAN I/F 59a and the wired LAN I/F 59b the present invention may be applied to a case that the printing apparatus 50 is provided with a plurality of wired LAN I/Fs (39b, 59b) instead of the wireless LAN I/F 59a.

What is claimed is:

1. A communication system, comprising:
at least one peripheral device having a plurality of interfaces; and
a host computer which is capable of communicating with the at least one peripheral device through any one of the plurality of the interfaces,
wherein the at least one peripheral device comprises:
a storing system to store configuration information which determines an operation of each of the interfaces; and
a configuration information transmission system to transmit the configuration information of each of the interfaces stored in the storing system to the host computer through any one of the plurality of the interfaces which are capable of communicating with the host computer,
wherein the host computer comprises:
a configuration information reception system to receive the configuration information of each of the interfaces transmitted by an operation from the configuration information transmission system from the at least one of the peripheral device; and
a setting screen display system to display a setting screen with the configuration information in the storing system being indicated therein on an interface basis according to the configuration information received by the configuration information reception system.

2. The communication system according to claim 1,
wherein a screen display controlling system to display the setting screen of one of the interfaces that relays communication between the host computer and the at least one of the peripheral device preferentially among the plurality of interfaces provided to the at least one of the peripheral device on the setting screen display system is included in the communication system.

3. The communication system according to claim 2,
wherein the setting screen display system is configured to switchably display the setting screen for each of the interfaces on a display unit according to an instruction from a user; and
wherein the screen display controlling system is configured to display the setting screen of one of the interfaces that relays communication between the host computer and the at least one of the peripheral device preferentially among the plurality of interfaces provided to the at least one of the peripheral device as an initially displayed screen on the setting screen display system.

4. The communication system according to claim 2,
wherein the at least one peripheral device includes an interface connected to a wired network and an interface connected to a wireless network as the plurality of the interfaces.

5. The communication system according to claim 2,
wherein the setting screen is configured to accept an updating operation related to the configuration information being stored in the storing system of the at least one peripheral device;
wherein the host computer comprises an update instructing system to transmit an update instruction signal to the at least one peripheral device according to an operation from the user to the setting screen displayed in a display unit by the setting screen display system, the update instruction signal being a signal to indicate updated configuration information for updating the configuration information; and
wherein the at least one peripheral device comprises a configuration updating system to rewrite the configuration information stored in the storing system according to the received instruction signal when the at least one peripheral device receives the update instruction signal from the host computer through any one of a plurality of the interfaces.

6. The communication system according to claim 1,
a screen display controlling system to display the setting screen of one of the interfaces that relays communication between the host computer and the at least one of the peripheral device preferentially among the plurality of interfaces provided to the at least one of the peripheral device on the setting screen display system is included in the communication system, and
wherein a preferential information storing system to store identification information of one of the plurality of interfaces for which setting screen is to be displayed preferentially, a preferential information updating system to update the identification information of one of the plurality of interfaces stored in the preferential information storing system with identification information of the another one of the plurality of interfaces instructed by a user, and a screen display controlling system to display the setting screen of one of the interfaces that corresponds to the identification information stored in the preferential information storing system preferentially among the plurality of interfaces provided to the at least one of the peripheral device on the setting screen display system is included in the communication system are included in the communication system.

7. The communication system according to claim 5, wherein the preferential information storing system, the preferential information updating system, and the screen display controlling system are provided in the host computer.

8. The communication system according to claim 5,
wherein the setting screen display system is configured to switchably display the setting screen for each of the interfaces on a display unit according to an instruction from a user; and
wherein the screen display controlling system is configured to display the setting screen of one of the interfaces that corresponds to the identification information stored in the preferential information storing system preferentially among the plurality of interfaces provided to the at least one of the peripheral device as an initially displayed screen on the setting screen display system.

9. The communication system according to claim 7,
wherein the at least one peripheral device includes an interface connected to a wired network and an interface connected to a wireless network as the plurality of the interfaces.

10. The communication system according to claim 5,
wherein the setting screen is configured to accept an updating operation related to the configuration information being stored in the storing system of the at least one peripheral device;
wherein the host computer comprises an update instructing system to transmit an update instruction signal to the at least one peripheral device according to an operation from the user to the setting screen displayed in a display unit by the setting screen display system, the update instruction signal being a signal to indicate updated configuration information for updating the configuration information; and
wherein the at least one peripheral device comprises a configuration updating system to rewrite the configuration information stored in the storing system according to the received instruction signal when the at least one peripheral device receives the update instruction signal from the host computer through any one of a plurality of the interfaces.

11. A peripheral device, comprising:
a plurality of interfaces for communicating with a host computer;
a storing system to store configuration information which determines an operation of each of the interfaces; and
configuration information transmission system to transmit the configuration information of one of the plurality of interfaces to the host computer issuing a request signal for the configuration information through one of the plurality of interfaces when the request signal for the configuration information from the host computer is received through one of the plurality of interfaces while the configuration information for each of the plurality of interfaces is stored in the storing system.

12. The peripheral device, according to claim 11,
wherein the configuration information transmission system transmits information configuring a web page, in which the configuration of the interface that received the request signal is described, while the web page is included in a setting screen to accept an updating operation related to the configuration information of the interface that received the request signal, to the host computer issuing the request signal for the configuration information through one of the plurality of interfaces when the request signal for the configuration information from the host computer is received through one of the plurality of interfaces while the configuration information for each of the plurality of interfaces is stored in the storing system, and
wherein a configuration updating system to rewrite the configuration information stored in the storing system according to the received instruction signal when the peripheral device receives the update instruction signal from the host computer given by the user through the web page is provided in the peripheral device.

13. The peripheral device, according to claim 12,
wherein the web page to be transmitted by the configuration information transmission system is provided with link information to request for a web page which is included in the setting screen related to the other interfaces than the interface corresponding to the configuration information capable of being updated through the web page included in the setting screen; and
the configuration information transmission system transmits the web page included in the setting screen to accept an updating operation for updating the configuration information of the interface corresponding to the link information to the host computer issuing the request signal when the request signal transmitted according to the link information is received by the configuration information transmission system while the web page includes the configuration information for the interface corresponding to the link information.

14. The peripheral device, according to claim 11, comprising an interface connected to a wired network and an interface connected to a wireless network as the plurality of the interfaces.

15. A computer usable medium comprising computer readable instructions for controlling a computer having a plurality of interfaces for communicating with an external device and a storing system to store configuration information which determines an operation of each of the interfaces to execute steps of:
transmitting the configuration information of one of the plurality of interfaces to the external device issuing a request signal for the configuration information through one of the plurality of interfaces when the request signal for the configuration information from the external device is received through one of the plurality of interfaces while the configuration information for each of the plurality of interfaces is stored in the storing system.

16. The computer usable medium according to claim 15,
wherein the web page to be transmitted in the configuration information is provided with link information to request for a web page which is included in the setting screen related to the other interfaces than the interface corresponding to the configuration information capable of being updated through the web page included in the setting screen; and
a step to rewrite the configuration information stored in the storing system according to the received instruction signal when the computer receives the update instruction signal from the external device given by the user through the web page is included in the steps to be executed by the computer.

17. The computer usable medium according to claim 15,
wherein the web page to be transmitted in transmitting the configuration information is provided with link information to request for a web page which is included in the setting screen related to the other interfaces than the interface corresponding to the configuration information capable of being updated through the web page included in the setting screen; and wherein the steps executed by the computer includes transmitting the web page included in the setting screen to accept an updating operation for updating the configuration information of the interface corresponding to the link information to the external device issuing the request signal when the request signal transmitted according to the link information is received by the configuration information transmission system while the web page includes the configuration information for the interface corresponding to the link information.
